(19) United States
(12) Patent Application Publication
(10) Pub. No.: US 2018/0005109 A1
(43) Pub. Date: Jan. 4, 2018

(54) Deep Learning Neuromorphic Engineering

(71) Applicant: Harold Szu, Bethesda, MD (US)

(72) Inventor: Harold Szu, Bethesda, MD (US)

(21) Appl. No.: 15/605,939

(22) Filed: May 25, 2017

Related U.S. Application Data
(60) Provisional application No. 62/341,478, filed on May 25, 2016.

(51) Int. Cl. G06N 3/063; G06N 3/08; G06N 5/02; G06F 17/50

(52) U.S. Cl. CPC G06N 3/063; G06N 5/02; G06N 3/08; G06F 17/5009; G06N 5/022

(57) ABSTRACT

A deep learning neuromorphic system includes an electronic circuit having input ports and an output port. The input ports are configured to receive differential photon detector outputs as circuit inputs. The electronic circuit is configured to apply unsupervised deep learning rules to the circuit inputs to provide a current mirror output. The output port is configured to provide the current mirror output to a plotter. A method of deep learning neuromorphic application includes receiving differential photon detector outputs as inputs to an electronic circuit. The electronic circuit applies unsupervised deep learning rules to the inputs to provide a current mirror output. The current mirror output is provided to a plotter.

### CROSS-REFERENCE TO RELATED DOCUMENT

This is related to, and claims priority from, U.S. Provisional Application for Patent No. 62/341,478, which was filed on May 25, 2016, the entire disclosure of which is incorporated herein in its entirety.

### FIELD OF THE INVENTION

The invention relates to deep learning processes, and to electronic circuits used to simulate and implement deep learning rules.

### BACKGROUND OF THE INVENTION

The principle of minimum energy is well known in physics, and is based on the second law of thermodynamics. The principle states that in a closed system having constant external parameters (such as the volume and any outside forces or influences) and entropy, the internal energy will decrease and approach a minimum value at equilibrium. A closed system is not isolated, but rather is connected to another system, and can exchange energy, such as heat, with the other system, but can't exchange matter. Thus, in a closed system, entropy remains constant, and therefore the energy of that system decreases to a minimum value at equilibrium, in the process transferring its energy to the other system.

The Minimum Free Energy (MFE) of the brain ΔH_{brain}≡ΔE_{brain}−TₒΔS_{brain}≦0, consistent with the irreversible thermodynamics of a total system including the brain and its isothermal environment at Tₒ:ΔSₜₒₜ>0. The gradient force of MFE is biologically known as the chemical affinity. It is known that the four major forces of physics, namely, gravitational, electromagnetic, strong (Yukawa potential), and weak (Fermi neutron decay) have a divergent singularity due to a small denominator that defines the existence of gravitational inertial mass, the Coulomb charge, the Mason particle, and the neutrino particle. Likewise, the singularity of the MFE gradient force defines the existence of glial cells.

$$\vec{G} ≡ - \frac{Δ H}{Δ \vec{S}}$$

Unsupervised Deep Learning (UDL) requires a house-keeping servant glial cell per thresholding logic node, namely a brain-style neuron. The linear synaptic weight matrix adjustment has been derived in the manner of D.O. Hebb circa 1950, as well as nonlinear morphology learning of hidden layer architecture, known as deep learning (DL). Recently, leading Internet companies have invested in major efforts in this field, resulting in a number of accomplishments. For example, Andrew Ng of the Google Brain deep learning project developed a neural network trained using deep learning algorithms to learn to recognize higher-level concepts, such as cats, after watching only YouTube videos and without first having been told what a cat is. Yann LeCun preformed artificial intelligence (AI) research for Facebook and developed arbitrary face expression recognition. George Dahl did deep learning AI research at Microsoft and is currently a research scientist at Google for speech recognition. Such a unified capability may be referred to as a Caianiello-Hebb-Ng-LeCun-Dahl (CHNLD) Deep Learning Rule (DLR).

It has also been observed that with respect to survival, nature seems to prefer pluralism, regarding endothermic vs. exothermic intelligence as cephalopods like octopus and cuttlefish have demonstrated stunning levels of intelligence, including puzzle solving and even learning through observation. Nonetheless, we can derive unsupervised deep learning rules by observing the necessary and sufficient conditions of warm blood animals roaming the Earth, which have an average brain temperature <T_{brain}>≈Tₒ kept at a mean value controlled by the brain's hypothalamus center, although the mean and variance of this temperature differs from species to species. For example, chicken and other bird brains are kept at a temperature of 40° C., perhaps for in order to have a body temperature that is capable of hatching eggs, whereas Homo sapiens brains and bodies are kept around at 37° C. to provide optimum elasticity of red blood hemoglobin cells, allowing them to squeeze through capillaries, emulating an ocean environment. Further, all animals receive sensory inputs in pairs, thus giving rise to a linear vector time series.

Knowledge representation is a field of AI dedicated to representing information about the world in a form that a computer system can utilize to solve complex tasks. With isothermal equilibrium and <T_{brain}>≈Tₒ, and a linear vector time series [symbol] (t)=[A] [symbol] (t) in 10D including an unknown mixing matrix [A], the Internal Knowledge Representation (IKR) [symbol] is an ensemble of the degree of different uniformity { [symbol] }, known as entropy in thermodynamics. One can apply the Ludwig Boltzmann definition of the total entropy to the brain and the brain's surrounding environment as a measure of the total degree of uniformity, and also his assertion of irreversible thermodynamic heat death ΔSₜₒₜ>0, due to the incessant molecular collisional mixing that produces greater uniformity. The inverse turns out to be the Maxwell-Boltzmann Canonical Probability

$$\begin{matrix} {S}_{tot} ≡ {k}_{B} log {W}_{tot} ; & ( 1 ) \\ {W}_{tot} = exp ( \frac{{S}_{tot}}{{k}_{B}} ) = exp ( \frac{( {S}_{brain} + {S}_{environment} ) {T}_{o}}{{k}_{B} {T}_{o}} ) = exp ( - \frac{{H}_{brain}}{{k}_{B} {T}_{o}} ) & ( 2 )\end{matrix}$$

where H_{brain}≡E_{brain}−TₒS_{brain} turns out to be the Helmholtz free energy, that is, energy that is available to do work after subtracting the exhaust thermal waste energy TₒS_{brain}. This derivation makes use of the conservation of energy, ΔEₜₒₜ=TₒΔSₑₙᵥᵢᵣₒₙₘₑₙₜ+ΔE_{brain}=0, such that the internal brain energy can exchange with environmental thermal energy.

Note the use of a scalar S in Eq. (1); the Boltzmann thermodynamic entropy denoted by the scalar S is used as the measure of the degree of uniformity, which helps define the important isothermal Helmholtz MFE in the brain-style computation of Eq. (2). Intuitively, this is similar to a principle of paleontology in which mountain-top rocks have less uniformity and therefore less information when compared to eroded beach sand having much more uniformity and a larger entropy value, without having much paleontological information (except the emotional sensation e-IQ). However, the vector [symbol] denotes the ordered set of components of different uniformity of the computational thresholding “nodes”, emulating brain-style “neurons” that have different MFE states.

Dropping the explicit function of time of the incoming exemplar data [symbol] (t), they can be collected as an ensemble of exemplars with stable mean, variance, and kurtosis { [symbol] }. The input layer of sensor vector data time series can be given in an ensemble denoted by the angular brackets.

{ [symbol] }=[A]{ [symbol] ₙ} (3)

The IKR has multiple hidden layers connecting layer to layer, [symbol] , n=1, 2, 3, . . . . Furthermore, the n-th layer of deep learning is connected through the dendritic trees to the adjacent n+1st layer of neurons in the hidden layers of IKR. The change in the MFE, ΔH_{brain}, can help determine the synaptic weight per exemplar realization

[W] [symbol] =\vec{S}ₙ. (4)

According to the invention, nonlinear morphology UDL rules are derived that can automatically change the architecture of hidden layers, that is, recruiting nodes or not (namely pruning) into functional units among layers of our brain hidden from the outside world. This is not unlike the anecdotal biological fact that male finch bird sing a new song every spring to attract female finch bird in order to lay more fraternized eggs of brainy offspring.

Δ\vec{S}≡\vec{S}ₙ₊₁−\vec{S}ₙ=\vec{S}ₙ₊₁−[W] [symbol] >0, (5)

For further background, see the references cited infra, the contents of which are incorporated herein in their entireties.

### BRIEF SUMMARY OF THE INVENTION

According to an aspect of the invention, a deep learning neuromorphic system includes an electronic circuit having input ports and an output port. The input ports are configured to receive differential photon detector outputs as circuit inputs. The electronic circuit is configured to apply unsupervised deep learning rules to the circuit inputs to provide a current mirror output. The output port is configured to provide the current mirror output to a plotter.

The differential photon detector outputs can be associated with a minimum free energy of a subject brain. The unsupervised deep learning rules can predict the glial cell force voltage of the subject brain. The current mirror output can relate to the glial cell force voltage.

The system can include the photon detector. The photon detector can be configured to receive a video input and provide a corresponding differential output.

The electronic circuit can include three-port semiconductor devices.

The system can include the plotter.

The electronic circuit can be configured as a system-on-chip.

According to another aspect of the invention, a method of deep learning neuromorphic application includes receiving differential photon detector outputs as inputs to an electronic circuit. The electronic circuit applies unsupervised deep learning rules to the inputs to provide a current mirror output. The current mirror output is provided to a plotter.

The method can include associating a minimum free energy of a subject brain with the differential photon detector outputs. The method can include using the unsupervised deep learning rules to predict the glial cell force voltage of the subject brain. The method can include relating the current mirror output to the glial cell force voltage.

The method can include using a photon detector to receive a video input and provide a corresponding differential output.

The electronic circuit can include three-port semiconductor devices.

The electronic circuit can be configured as a system-on-chip.

The method can also include making a pruning decision based on the current mirror output.

### BRIEF DESCRIPTION OF THE DRAWINGS

FIG. 1 shows exemplary elements of a fault-tolerant UDL associative memory neural network: FIG. 1A is a binary feature space for a big nose uncle; FIG. 1B is a binary feature space for a big eye aunt; and FIG. 1C is a schematic representation of an ANN connectivity weighted matrix circuit.

FIG. 2 is a schematic diagram of an exemplary neuromorphic circuit according to the invention.

FIG. 3 is a plot of the unsupervised deep learning sigmoid threshold logic rule implemented by the circuit of FIG. 2.

### DETAILED DESCRIPTION OF THE INVENTION

### Morphology of Neuromorphic Engineering for Fault Tolerance (FT):

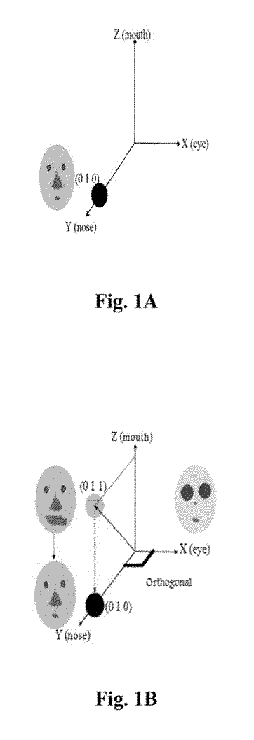

An artificial neural network (ANN) weighted matrix [W] is illustrated in FIG. 1. In FIG. 1A, the big nose uncle is represented in the binary feature space as having a small eye, a big nose, and a small mouth, thus, (0, 1, 0). Similarly, in FIG. 1B, the big eye aunt having a small nose and small mouth is represented by (1, 0, 0). In the schematic circuit drawing of FIG. 1C, neuromorphic engineering indicates the thresholding node as a circle and the ANN connectivity weighted matrix [W] has UDL Self-Organization (SO) elements indicated as tunable impedance values.

Ad hoc DL might take place when more traffic flows through, as the impedance value would be reduced proportionally according to the definition of SO. The fault tolerance (FT) of massive parallel and distributed (MPD) processing is a result of the geometry in taking the threshold of the nearest neighbor indicated in FIG. 1A and FIG. 1B. This can be easily explained as follows. When the big nose uncle smiles at us, we find the feature space to be (0, 1, 1) (mouth size increases) recalling by the nearest neighbor rule in their direction cosine distance, as shown a memory state of big nose uncle when smiles (in the first quadrant) is also recognized as the uncle. Therefore, the big nose uncle is differentiated from the big eyed aunt. A 1 reflects a big difference, a 0 means no difference.
Three binary feature neurons f=(n₁, n₂, n₃) are used to represent (eye, nose, mouth), and sigmoid threshold round off to binary (1, 0)≡(big, small).
Neural network is trained for feature f₁≡(n₁, n₂, n₃)≡(eye, nose, mouth)≡(0 1 0), for example, big nose uncle, and build these three neurons in a 3-D domain shown as follows.
If a new feature input is feature f_{new}≡(n₁, n₂, n₃)≡(eye, nose, mouth)≡(0 1 1), the associative memory can detect and correct the feature back to (0 1 0) big nose uncle by the direction cosine 45° nearest neighbor threshold.

### Hardware Design of UDL Rule as System on Chip (SoC) Firmware Operable at Every Node or Pixel

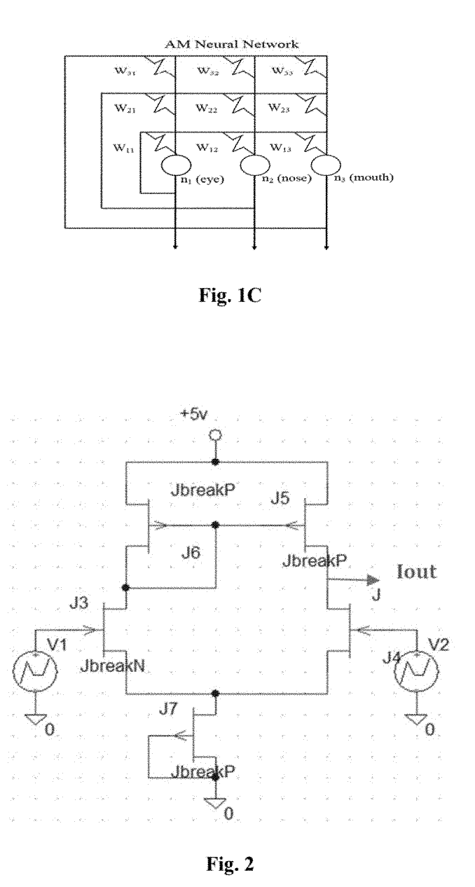

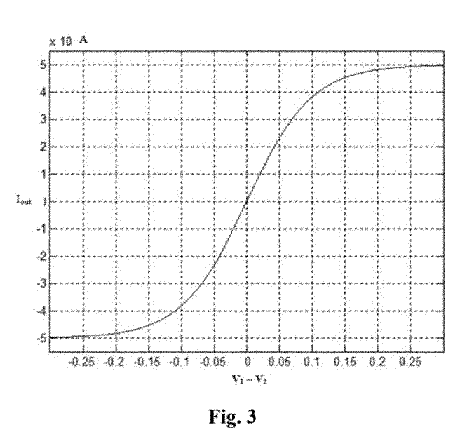

Difference sensing directly on a photonic detector in different sequential timing should be adaptive to incoming moving film for Automatic Pattern Recognition (APR), the speed of which is estimated from its neighborhood's projected changes. These neighborhood current fluctuations of Photon Detectors (PDs) can be measured using a Complementary Metal-Oxide Semiconductor (CMOS) Transconductance Amplifier (TA), which converts the voltage potential to current as shown in FIG. 3. The output current of a custom-designed TA is a function of differential input voltages, which generates a linear regime and no-change is represented by a flattened curve, as plotted by a SPICE (UC Berkeley) simulation. In an exemplary CMOS configuration, the linear gate voltage region of the differential input voltage between the pair of N-type transistors is −0.1V and 0.1 V, and can be connected to detect the number of photons in different sequential timing. The exemplary circuit consists of a differential pair and a single current mirror as shown in FIG. 2, and the SPICE simulation is plotted as shown in FIG. 3 in the space of the voltage difference (V₁-V₂) and the drain current Iₒᵤₜ. Parameters of the CMOS configuration, such as the length and width of the CMOS transistors, have to be carefully selected to expand the linear region in support of compressive video change detection.

The circuit of FIG. 2 can be fabricated as a semiconductor SoC, for example designed and built using open source freeware such as Purdue's Cadence design tool, and then applied to the implementation of process of the invention, using three-port semiconductors, for example, semiconductor devices have an anode, a cathode, and a gate. In this design, the circuit has two ports-the left and right lower corners (denoted V₁ and V₂), which are the gate potential taken sequentially from a photon detector (PD) where, for example, video inputs such as YouTube videos have been constantly provided for prior and subsequent intensities, and the difference is the output current Iₒᵤₜ located at the right-hand side middle portion by locally and adaptively modifying the time span between the PD V₁ and V₂, respectively, according to neighborhood MFE glial cells and its input movie frame light intensity.

### UDL Principle 1:

### Lazy Brains Learning Cost Function is the Minimum Free Energy (MFE)

### Proof:

Boltzmann entropy Eq. (1) defines Maxwell-Boltzmann Probability, Eq. (2),

$${W}_{MB} = exp ( - \frac{{H}_{brain}}{{k}_{B} {T}_{o}} )$$

Then, the Boltzmann irreversible heat death ΔSₜₒₜ>0 due to incessant inter-molecular collisions smoothing the degree of uniformity measured by the entropy

ΔH_{brain}=ΔE_{brain}−TₒΔS_{brain}≦0

That is, Min. ΔH_{brain}≡ΔE_{brain}−TₒΔS_{brain}≦0 free to do the work, similar to how in a gasoline internal chemical energy reaction, the exhaust waste heat energy must be extracted in order for the mechanical expansion to take place. Q.E.D.

### Corollary: Homeostasis Brains

Higher homeostasis temperatures do not imply higher intelligence.

### Proof:

It is difficult to conduct test and evaluation on this corollary. However, based on the fact that Homo sapiens eat chicken; but not vice versa, it is assumed that we are smarter in most real world activities. Q.E.D.

### UDL Principle 2:

### UDL Rule Implemented the Brittleness of Bi-Linear Interconnectivity

### Proof:

Use has been made of the chain rule and partial differentiation of layered morphology defined by Eq. (5):

$$\frac{Δ [ W ]}{Δ t} = - \frac{Δ {H}_{brain}}{Δ [ W ]} = - ( \frac{Δ {H}_{brain}}{Δ \vec{S} ( t )} ) \cdot ( \frac{Δ \vec{S} ( t )}{Δ [ W ]} ) = [ {\vec{G}}_{glial} {\vec{X} ( t )}^{T} ] . \qquad ( 6 )$$

There exists an implicit threshold at the exponential-folding length e⁻¹≈0.7 for the passing over weakly linear Hebb rule to the binary states controlled by the thermal energy brittleness

$${k}_{B} {T}_{o} = \frac{1}{50} e V . Q . E . D$$

### UDL Principle 3:

### The Existence of House-Keeping Servant Glial Cells

### Proof:

The divergence of the MFE gradient force [symbol] _{glia}≡−ΔH/Δ [symbol] , relative to the difference of the MFE ΔH=ΔH_{recruiting}−ΔH_{pruning} gradient force is biologically known as the chemical affinity, the physical space exclusion of which proves the existence of a finite-size house-keeping servant glial cell, one per neuron, about 1/10^{th} the size of the neuron.

$$Δ {H}_{brain} = ( \frac{Δ {H}_{brain}}{Δ \vec{S} ( t )} ) \cdot Δ \vec{S} ( t ) = - ( \frac{Δ {H}_{brain}}{Δ \vec{S} ( t )} ) \cdot \{ Δ \vec{S} ( t ) \} ≡ {\vec{G}}_{glial} \cdot \{ - Δ {\vec{S}}_{recruit} ( t ) \} \leq 0 ; \qquad ( 7 )$$

Weak ΔH_{brain} [symbol] o(|Δ [symbol] |¹);

$${\vec{G}}_{glial} ≡ - \frac{Δ H}{Δ \vec{S}} ⇒ o ( 0 ) pruning ; Δ \vec{S} ⇒ 0 + ɛ ( glial \& neuron ) \qquad ( 8 )$$

On the other hand, the regularity of the divergence sustains a constant force

Strong ΔH_{brain} [symbol] o(const.);

$${\vec{G}}_{glial} ≡ - \frac{Δ H}{Δ \vec{S}} ⇒ o ( ∞ ) recruiting ; Δ \vec{S} ⇒ 0 ɛ ( glial \& neuron ) , \qquad ( 9 )$$

which implies the node activity is significant for the house-keeping nodal glial cells to recruit the node into functional units. The mathematical regularization of the divergence is accomplished because the physical exclusion size is prevented from reaching the zero distant origin by the geometry size of the house-keeping servant glial cell, which as noted above is about 1/10^{th} the size of a neuron and defines the importance of the specific axon connectivity of the neighboring neuron nodes. For example, a reduction of the MFE force for insignificant nodes calls for the pruning mechanism.

Remarks are in Order

The unified field theory of all the four major physical forces, namely, gravitational, electromagnetic, strong nucleon, and weak neutron, requires nature to define the mass, the charge, the mason, and the neutrino. Likewise, the singularity of the brain MFE gradient force defines the existence of glial cells, see Eqs. (9, 10).

Note that a male finch bird can recruit its auditoria neural nodes to sing a new song every spring to attract a female finch bird (Paton, J. A.; Nottebohm, F. “Neurons generated in the adult brain are recruited into functional circuits,” SCIENCE 1984; 225(4666):1046-1048, Rockefeller Univ. circa 1970). UDL may be defined, like a Zebra finch bird, as follows: Not only can the brain UDL synaptic junctions among neurons have minor synaptic weight adjustment according to the Hebb linear product of the input and output rule (intuitively, a pipe of efficient I/O capability has a larger cross section of axon with a lower impedance), but also UDL can have dynamic architecture recruiting or not in the morphology by allowing a top layer to decide where to prune nodes and to recruit a lower layer's node at those layers hidden from the outside input world. This is the UDL of the IKR mechanism.

### UDL Theorem 4:

### Unsupervised Deep Learning Rule

The MFE gradient force [symbol] ≡−ΔH/Δ [symbol] can determine the architecture of morphological learning with UDL, known as the CHNLD Rule.

### Proof:

Given growing or pruning recruiting neurons and layers into functional units, Maxwell-Boltzmann probability is applied to recruit-or-not a two-state normalization for the Nonlinear Sigmoidal Morphologic Rule

$$\frac{exp ( - \frac{Δ {H}_{recruiting}}{{k}_{B} {T}_{o}} )}{exp ( - \frac{Δ {H}_{recruiting}}{{k}_{B} {T}_{o}} ) + exp ( - \frac{Δ {H}_{pruning}}{{k}_{B} {T}_{o}} )} = \frac{1}{1 + exp [ ( \frac{\begin{matrix}Δ {H}_{recruiting} - \\ Δ {H}_{pruning}\end{matrix}}{Δ \vec{S}} ) \cdot Δ \vec{S} / {k}_{B} {T}_{o} ]} ≡ ϑ ( Δ {\vec{G}}_{glial} \cdot Δ \vec{S} ) = \{ \begin{matrix}0.7 \sim 1.0 recruiting \\ 0.3 \sim 0.0 pruning\end{matrix} \qquad ( 10 )$$

where the MFE gradient force defines the biological house-keeping servant glial cell per neuron:

[symbol]

_{glial}≡−ΔH/Δ [symbol] (11)

given the MFE determined by the ensemble input data { [symbol] }

$${H}_{brain} = {E}_{brain} - {T}_{o} {S}_{brain} = {E}_{o} + {( \frac{\partial {E}_{brain}}{\partial \vec{S}} )}_{o} \cdot ( [ W ] \vec{X} - {\vec{S}}_{n} ) + … - {T}_{o} {S}_{brain} , \qquad ( 12 )$$

as well as the UDL Rule of the synaptic weight matrix

$$\frac{Δ [ W ]}{Δ t} = - \frac{Δ {H}_{brain}}{Δ [ W ]} = - ( \frac{Δ {H}_{brain}}{Δ \vec{S}} ) \cdot ( \frac{Δ \vec{S}}{Δ [ W ]} ) = [ \vec{G} {\vec{X}}^{T} ] ; \\ [ W ] - {[ W ]}_{o} = [ \vec{G} {\vec{X}}^{T} ] {( Δ t )}_{o} . \qquad ( 13 )$$

Q.E.D.

### CONCLUSIONS

The isothermal free energy H_{brain}=E_{brain}−<Tₒ>S_{brain} gradient force is the House-Keeping Servant (HKS) Glial Cells (GC) force:

$${\vec{G}}_{glial} ≡ - ( \frac{Δ {H}_{brain}}{Δ \vec{S}} ) ,$$

where E_{brain} is the internal energy and S_{brain} is the measure of degree of uniformity, called entropy. The change in free energy toward the minimum is responsible for the self-organizational shift of the Hidden Deep Layer Architecture shape, from a beer belly shape to the hour-glass of ANN. Thus, the “learning machines” prosaically emulate the biological “brains”.

The Supervised Alan Turing (SAT) tests from the original definition of AI, which took days to evaluate using a supercomputer, is updated as an Unsupervised Turing Test (UTT), taking mere hours to evaluate using a PC. This is more than undifferentiated from a human at another computer terminal, but also can defeat a human most of the time in certain tasks, generalized as Unsupervised Natural Intelligence (NI).

The unsupervised learning rule of hidden deep layers architecture is Δ [symbol] ≡ [symbol] ₙ₊₁−[W] [symbol] , n=1, 2, 3, . . . . The vector [symbol] ₙ₊₁ denotes each computing threshold logic node of different degrees of uniformity, this measure called entropy S driven by the ensemble of exemplar input data { [symbol] }. While the strength increases and passes a threshold Δ [symbol] for the recruiting node for a growing architecture, the strength for pruning diminishes. The weighted Maxwell-Boltzmann probability W_{MB}=exp(−ΔH_{brain}/k_{B}Tₒ), ΔH_{brain}=ΔH_{recruiting}−ΔH_{pruning} by a soft sigmoid threshold derived by the two-state normalization

$$ϑ ( Δ \vec{G} \cdot Δ \vec{S} ) ≡ \frac{1}{1 + exp ( Δ {\vec{G}}^{T} \cdot Δ \vec{S} ) / {k}_{B} {T}_{o} )} ≅ \{ \begin{matrix}0.7 \sim 1.0 recruiting \\ 0.3 \sim 0.0 or not , i . e . pruning\end{matrix} ; \\ \vec{G} ≡ - \frac{Δ H}{Δ \vec{S}} ⇒ o ( 0 ) pruning ; or , ∞ recruiting , where Δ \vec{S} ⇒ 0 + ɛ ( glial \& neuron sizes )$$

where, the unknown equilibrium constant drops out in the changing ΔH_{brain} slope for glial cells, except the connectivity matrix and data ensemble, [W] [symbol] .

The efficiency of new unsupervised capability is driven by the natural relaxation toward less energy and more entropy, namely the MFE inequality ΔH=ΔE_{brain}−<Tₒ>ΔS_{brain}≦0. The unsupervised learning capability is derived from the Boltzmann assertion of irreversible heat death ΔS_{brain}>0 of a closed system due to increasing uniformity generated by incessant inter-molecular collisions as a consequence of Nernst thermodynamic 3^{rd} law Tₒ≧0.

The UDL Rule of the synaptic weight matrix [W] driven by the incoming image ensemble {\vec{X}} dynamic interconnectivity of ANN, whether to be recruiting or not, namely pruning with the threshold to be empirically obtained from the stable mean, variance, and kurtosis of the exemplar ensemble of images, or voice, or video, or gaming {\vec{X}} without human supervision.

$$\frac{Δ [ W ]}{Δ t} = - \frac{Δ {H}_{brain}}{Δ [ W ]} = - ( \frac{Δ {H}_{brain}}{Δ \vec{S}} ) \cdot ( \frac{Δ \vec{S}}{Δ [ W ]} ) = [ {\vec{G}}_{glial} {\vec{X}}^{T} ] ; \\ [ W ] - {[ W ]}_{o} = [ {\vec{G}}_{glial} {\vec{X}}^{T} ] {( Δ t )}_{o} ,$$

where the superscript T is the transpose operation that turns a row into column and vice versa.

As described above, FIG. 2 shows a circuit implementation of the UDL Rule for the unsupervised learning morphology architecture of an ANN including the ad hoc CHNLD, which is can be embodied as an SoC. Purdue's Cadence design tool is applied to the implementation, which includes semiconductors having three ports—an anode, a cathode, and a gate. In this design, the circuit has two ports—the left port is the gradient of MFE, the singularity of which predicts the glial cell force voltage V₁≈Δ [symbol] _{glial}≡−ΔH_{brain}/Δ [symbol] deciding the threshold of whether or not to recruit (that is, pruning) and the right lower corner denotes the input movie pixel intensity V2≈movie pixel, which is the gate potential taken from a photon detector.

### Remarks

The morphology changes may be described as “Netted Sensing” in the real world surveillance application of Computational Intelligence (CI) training with the UDL rule.

While the MFE will cause glial force pruning of the insignificant next layer neurons, the MFE can also significantly grow the connection of IKR of next layer neurons, with the help of the hypothalamus brain center command secreting immunoreactivities hormones and dopamine (cf. Paul Greengard, et al.).

Of course, the devil of ANN training is in the details, and the time history of exposure makes difference, when the learning process alters the morphology. Such a dual capability of adaptive weights and morphology changes is the hallmark of modern deep-layer learning. Short term memory (STM) is located at the brain's frontal lobe. An average of the synaptic weights over the time <[W(t)]> can become long term memory (LTM) storage at the hippocampus, of which the left hemisphere is known to be logically rational, and the right hemisphere is mostly emotional, which fMRI hemodynamic imaging seems to confirm.

### REFERENCES

1. “The learning Machine,” by Nicola Jones, Nature Magazine V. 505, pp. 146-148, 9 Jan. 2014
2. “New Scientist”, weekly magazine, Mar. 19-25, 2016 (www.newscientist.com); pp. 20-22; p. 9
3. Deep Learning (hidden layers˜10 or more to 127) has been modernized by Ukraine Math A. G. Ivakhnenko, V. G. Lapa, R. N. McDonough “Cybernetics & forecasting Tech,” (Elsevier, N.Y. 1967).
4. Springer 2014, Li Deng & Dong Yu, “Deep Learning,” Meth. & Apps, Found. & Trends In Sign Proc. V. 7, pp. 197-387 (2013);
5. Springer 2013, Stellan Ohlison “Engineer General Intelligence.”
6. Springer 2013: Ben Goertzel et al. “Atlantis Thinking Machines.”
7. Cambridge U. P. 2006, Stellan Ohison, “How Minds overrode Experience.”

I claim:

1. A deep learning neuromorphic system, comprising:
an electronic circuit having input ports and an output port;
wherein the input ports are configured to receive differential photon detector outputs as circuit inputs;
wherein the electronic circuit is configured to apply unsupervised deep learning rules to the circuit inputs to provide a current mirror output; and
wherein the output port is configured to provide the current mirror output to a plotter.

2. The system of claim 1, wherein the differential photon detector outputs are associated with a minimum free energy of a subject brain.

3. The system of claim 2, wherein the unsupervised deep learning rules predict the glial cell force voltage of the subject brain.

4. The system of claim 3, wherein the current mirror output relates to the glial cell force voltage.

5. The system of claim 1, further comprising the photon detector.

6. The system of claim 5, wherein the photon detector is configured to receive a video input and provide a corresponding differential output.

7. The system of claim 1, wherein the electronic circuit includes three-port semiconductor devices.

8. The system of claim 1, further comprising the plotter.

9. The system of claim 1, wherein the electronic circuit is configured as a system-on-chip.

10. A method of deep learning neuromorphic application, comprising:
to receiving differential photon detector outputs as inputs to an electronic circuit;
applying, by the electronic circuit, unsupervised deep learning rules to the inputs to provide a current mirror output; and
providing the current mirror output to a plotter.

11. The method of claim 10, further comprising associating a minimum free energy of a subject brain with the differential photon detector outputs.

12. The method of claim 11, further comprising using the unsupervised deep learning rules to predict the glial cell force voltage of the subject brain.

13. The method of claim 12, further comprising relating the current mirror output to the glial cell force voltage.

14. The method of claim 10, further comprising using a photon detector to receive a video input and provide a corresponding differential output.

15. The method of claim 10, wherein the electronic circuit includes three-port semiconductor devices.

16. The method of claim 10, wherein the electronic circuit is configured as a system-on-chip.

17. The method of claim 10, further comprising making a pruning decision based on the current mirror output.
